(19) United States
(12) Patent Application Publication
(10) Pub. No.: US 2017/0249473 A1
(43) Pub. Date: Aug. 31, 2017

(54) METHOD FOR MANAGING PERMISSION POLICY OF APPLICATION IN AN ELECTRONIC TERMINAL

(71) Applicant: SAMSUNG ELECTRONICS CO., LTD., Suwon-si (KR)

(72) Inventor: Yong Lou, HangZhou City (CN)

(73) Assignee: SAMSUNG ELECTRONICS CO., LTD., Suwon-si (KR)

(21) Appl. No.: 15/367,562

(22) Filed: Dec. 2, 2016

(30) Foreign Application Priority Data
Feb. 25, 2016 (CN) 201610102898.2

(51) Int. Cl. G06F 21/62

(52) U.S. Cl. CPC G06F 21/6218

(57) ABSTRACT

A method for managing a permission policy of an application in an electronic terminal is provided. The method includes: obtaining an initial diagnostic script to create a diagnotor, a structure of the initial diagnostic script including an application identifier, an identifier of a permission policy diagnostic point, an application programming interface corresponding to the permission policy diagnostic point, an instruction corresponding to the permission policy diagnostic point, and a setting for a user's decision with respect to the instruction upon execution of the instruction; according to a control of the diagnotor, running a target application in a diagnostic mode; and when the permission policy diagnostic point is triggered during the running of the target application, executing the instruction corresponding to the permission policy diagnostic point, receiving the user's decision in accordance with the setting for the user's decision, and recording the user's decision with respect to the executed instruction.

### CROSS-REFERENCE TO RELATED APPLICATION

This application claims priority from Chinese Patent Application No. 201610102898.2, filed on Feb. 25, 2016 in the State Intellectual Property Office, the entire disclosure of which is incorporated herein by reference for all purposes.

### TECHNICAL FIELD

Apparatuses and methods consistent with exemplary embodiments relate to security management of an application on an electronic terminal, and more particularly, managing a permission policy of an application in an electronic terminal.

### BACKGROUND ART

In an embedded operating system, there are two main methods for managing an application permission policy, a static permission policy management method and a dynamic permission policy management method. The static permission policy management method presents its permission policies only during an installation of an application, such that if a user objects to certain permission policies, he/she may only choose whether or not to install the application. Furthermore, for an application that has already been installed, the static permission policy management method may only implement permission or denial of the application. If the application is denied, the application is uninstalled. Thus, although the static permission policy management is intuitive and efficient, the static permission policy management lacks flexibility.

Meanwhile, the dynamic permission policy management method may configure a permission policy list during an installation of an application, and, when an application genuinely uses a specific permission policy, may also allow a user to determine whether to grant the specific permission policy. However, when the user grants the permission policy, the codes of the various application programming interfaces (APIs) in a system should be modified. Thus, extensibility is relatively poor. In addition, if there is a need to add a new permission policy check, the codes of the corresponding API should also be modified, thereby resulting in poor portability.

### SUMMARY

Aspects of one or more exemplary embodiments provide a method for managing a permission policy of an application in an electronic terminal, through which the relatively poor flexibility, extensibility and portability of the related art method for managing a permission policy of an application in an electronic terminal may be overcome.

According to an aspect of an exemplary embodiment, there is provided a method for managing a permission policy of an application in an electronic terminal, the method including: obtaining an initial diagnostic script to create a diagnotor, a structure of the initial diagnostic script including a file header and a file content, wherein the file header includes an application identifier, an identifier of a permission policy diagnostic point, an application programming interface corresponding to the permission policy diagnostic point, an instruction corresponding to the permission policy diagnostic point, and a setting for a user's decision with respect to the instruction upon execution of the instruction; according to a control of the diagnotor, running a target application in a diagnostic mode; and when the permission policy diagnostic point is triggered during the running of the target application, executing the instruction corresponding to the permission policy diagnostic point, receiving the user's decision in accordance with the setting for the user's decision, and recording the user's decision with respect to the executed instruction.

According to an aspect of another exemplary embodiment, there is provided a method for managing a permission policy of an application in an electronic terminal, the method including: obtaining a diagnostic script to create a diagnotor, a structure of the diagnostic script including an instruction corresponding to a permission policy diagnostic point, and a setting for a user's decision with respect to the instruction upon execution of the instruction; according to a control of the diagnotor, running a target application; and when the permission policy diagnostic point is triggered during the running of the target application, executing the instruction corresponding to the permission policy diagnostic point and receiving the user's decision in accordance with the setting for the user's decision.

According to an aspect of another exemplary embodiment, there is provided a non-transitory computer-readable recording medium having recorded thereon instructions executable by at least one processor to perform a method for managing a permission policy of an application in an electronic terminal, the method including: obtaining a diagnostic script to create a diagnotor, a structure of the diagnostic script including an instruction corresponding to a permission policy diagnostic point, and a setting for a user's decision with respect to the instruction upon execution of the instruction; according to a control of the diagnotor, running a target application; and when the permission policy diagnostic point is triggered during the running of the target application, executing the instruction corresponding to the permission policy diagnostic point and receiving the user's decision in accordance with the setting for the user's decision.

### BRIEF DESCRIPTION OF THE DRAWINGS

The above and other objectives of exemplary embodiments will become apparent from the following detailed description, taken in conjunction with the accompanying drawings in which:

FIG. 1 is a flow diagram illustrating a method for managing a permission policy of an application in an electronic terminal according to an exemplary embodiment; and

FIG. 2 is a relationship diagram illustrating a process of a diagnostic mode according to an exemplary embodiment.

### DETAILED DESCRIPTION OF EXEMPLARY EMBODIMENTS

Hereinafter, a detailed reference will be made with respect to exemplary embodiments, one or more examples of which are shown in the drawings.

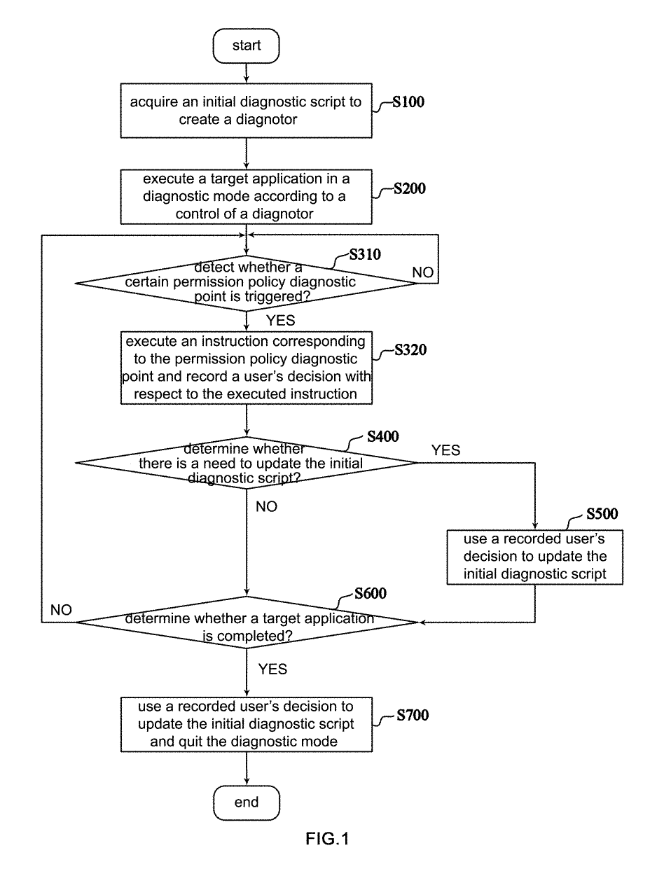

FIG. 1 is a flow diagram illustrating a method for managing a permission policy of an application in an electronic terminal according to an exemplary embodiment. As an example, the method may be performed by an electronic terminal for managing a permission policy of an application. The electronic terminal may be an electronic terminal having a plurality of applications installed therein, such as a smart phone, a tablet device, a personal computer (PC), a laptop computer, a handheld computing device, a wearable device, a camera device, a television device, a smart appliance, a smart device, a display device, a vehicle device, a game console, a multimedia player, etc.

Referring to FIG. 1, in operation S100, an initial diagnostic script is acquired or obtained to create a diagnotor.

Herein, the initial diagnostic script is an executable file programmed based on a certain format, which may be loaded and executed by an operating system. Specifically, a structure of the initial diagnostic script includes a file header and a file content. The file header includes at least one of an application name or identifier, a permission policy diagnostic point name or identifier, an application programming interface (API), an instruction corresponding to a permission policy diagnostic point, and a setting for a user's decision or input with respect to the executed instruction upon execution of the instruction corresponding to the permission policy diagnostic point. The file content is content corresponding to a configuration item (for example, a name of a permission policy diagnostic point, etc.) included in a file header. Herein, the permission policy diagnostic point indicates a function point related to a permission policy of a target application, for example, a permission policy diagnostic point may be “opening WIFI.”

Each application may correspond to one diagnostic script. Taking a WECHAT application (messaging application) as a target application by way of example, a structure of the initial diagnostic script is shown in Table 1 below:

TABLE 1
Structure of Initial Diagnostic Script

| | Permission Policy | Application | | |
|---|---|---|---|---|
| Application | Diagnostic Point | Programming | Executing | User's |
| Name | Name | Interface (API) | Instruction | Decision |
| WECHAT | Opening WIFI | setWifiEnable | No Action | Always |
| | | | | Allow |
| | Sending text | sendSMS | Popping | Always |
| | Message | | up | Inquire |
| | | | Selection | |
| | | | Box | |
| | Opening Data | setDataEnable | Displaying | Always |
| | | | Alert | Forbid |
| | . . . | . . . | . . . | . . . |

As an example, the initial diagnostic script may be a pre-configured diagnostic script or a default diagnostic script of an electronic terminal. In addition, when a user needs or wants to re-configure an initial diagnostic script, he/she may edit a diagnostic script through a user interface provided by a predetermined configurator. For example, a user may configure a permission policy diagnostic point, an instruction corresponding to a permission policy diagnostic point, etc., through a user interface provided by a configurator. By editing a diagnostic script through the user interface provided by the configurator, the configurations of a permission policy diagnostic point, an instruction corresponding to the permission policy diagnostic point, etc., may be more flexible.

According to another exemplary embodiment, based on different trust degrees of the download sources of applications, a user may pre-select an unsafe application (or any application having a download source of a particular trust degree) as a target application, and a diagnotor is further used in an electronic terminal to perform subsequent permission policy diagnosis on an application deemed to be unsafe by a user. For example, in operation S100, whether the target application is safe is determined. In this case, when it is determined that the target application is not safe, the initial diagnostic script is acquired to create a diagnotor. In this way, a targeted diagnosis may be performed with respect to a target application, thereby increasing an overall running speed of applications. According to an exemplary embodiment, an initial diagnostic script may be pre-stored in a local memory or downloaded from the network to a local memory. Also, when executing the method, an initial diagnostic script may be loaded into a cache.

In operation S200, according to a control of a diagnotor, a target application is executed in a diagnostic mode.

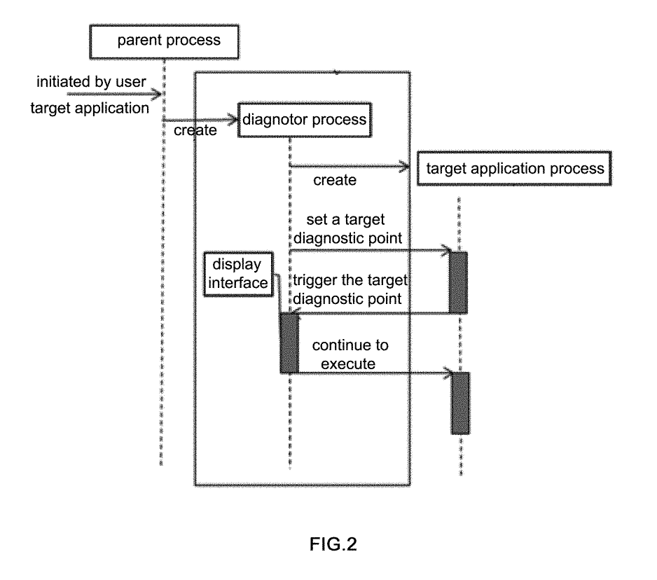

FIG. 2 is a relationship diagram illustrating a process of a diagnostic mode according to an exemplary embodiment.

As shown in FIG. 2, in a normal mode, a target application is generated directly by its parent process. On the other hand, in a diagnostic mode, a parent process generates a diagnotor process first and the diagnotor process then generates a target application process, such that a diagnotor process may fully control a target application process.

Referring to FIGS. 1 and 2, in operation S310, whether a certain permission policy diagnostic point is triggered in running a target application is detected. When no permission policy diagnostic point is triggered in running a target application, the method returns to operation S310. Conversely, when a certain permission policy diagnostic point is triggered in running a target application, in operation S320, an instruction corresponding to the permission policy diagnostic point is executed, and a user's decision with respect to the executed instruction is recorded. Herein, the certain permission policy diagnostic point may be a permission policy diagnostic point pre-configured before creating a diagnotor process, or may be a permission policy diagnostic point newly configured in an initial diagnostic script through a user interface provided by a predetermined configurator. Specifically, when a certain permission policy diagnostic point is triggered while running a target application, a diagnotor may cause a response to an event of the permission policy diagnostic point to be triggered based on an initial diagnostic script (for example, executing an instruction corresponding to the permission policy diagnostic point), and a user's decision with respect to the executed instruction is recorded.

For example, when a target application is a WECHAT application, a structure of the initial diagnostic script is shown in Table 1 above (that is, the contents of Table 1 represent a configuration of an initial diagnostic script corresponding to a WECHAT application). Based on the contents of Table 1, it can be seen that permission policy diagnostic points configured in an initial diagnostic script of a WECHAT application are “Opening WIFI,” “Sending Text Message,” and “Opening Data.” When a permission policy diagnostic point of “Opening Data” is triggered, according to a correspondence relationship recorded in the initial diagnostic script, a diagnotor may cause a response to an event of the permission policy diagnostic point of “Opening Data” to be triggered. That is, the diagnator may cause an alert prompt in a user interface to be displayed so as to determine a user's decision over a permission policy of “Opening Data.” In response, the user may perform an operation on the alert prompt (for example, “Always Open”, “Always Inquire” or “Always Forbid”, etc.) displayed in the user interface and take the operation as a decision overriding a permission policy of “Opening Data.” The diagnotor may perform and record the user's decision over the permission policy of “Opening Data.” Herein, it is understood that, when another permission policy diagnostic point is triggered, a diagnotor may perform the process by adopting a similar method.

Based on the above method, the corresponding permission policy of a target application may be configured flexibly in an electronic terminal. In addition, by adding a diagnotor, the user need not modify the codes of various APIs in a system in a process of granting a permission policy, thereby improving extensibility of permission policy management. In addition, when configuring a diagnostic script of a target application, a new permission policy diagnostic point may be added through a configurator, and the corresponding API codes may not be modified during the process of configuration, thereby improving portability of permission policy management.

According to another exemplary embodiment, the method for managing permission policy of application in an electronic terminal as illustrated in FIG. 1 may further include operations for updating an initial diagnostic script.

Specifically, referring again to FIG. 1, in operation S400, whether there is a need or an instruction to update the initial diagnostic script is determined.

When it is determined that there is a need to update the initial diagnostic script, in operation S500, a recorded user's decision is used to update the initial diagnostic script. For example, a recorded user's decision may be used to update the corresponding content in an initial diagnostic script in a cache (for example, a user's decision made with respect to the executed instruction when an instruction corresponding to a permission policy diagnostic point is executed). It is understood that in one or more other exemplary embodiments, operations S400 and S500 may be omitted.

Next, in operation S600, whether a target application is completed is determined (e.g., whether execution of the target application has completed, whether the application has been closed, whether an instruction to close the application has been received, etc.). In addition, when it is determined that there is no need or instruction to update the initial diagnostic script, operation S600 is performed as well. It is understood that, when it is determined that there is no need to update the initial diagnostic script, a target application is executed in a diagnostic mode according to the previous initial diagnostic script and whether a permission policy diagnostic point is triggered is detected accordingly.

When it is determined that the target application is not completed, the method returns to operation S310.

When it is determined that the target application is completed, in operation S700, a recorded user's decision is used to update the initial diagnostic script, and then quit the diagnostic mode. For example, a recorded user's decision may be used to update the corresponding content in an initial diagnostic script in a local memory (for example, a user's decision made with respect to the executed instruction when an instruction corresponding to a permission policy diagnostic point is executed). According to another exemplary embodiment, a user may be prompted so as to determine whether to update an initial diagnostic script in operation S700.

Additionally, as another example, when a target application is diagnosed for a period of time by using a diagnotor, a user may also choose to or not to keep using a diagnotor to manage a permission policy of a target application based on a trust degree to a target application.

For example, when a user determines that a target application is a safe application, he may send or input an indication that the target application is determined as a safe application. In response to the indication that a user determines that a target application is a safe application, a diagnotor may quit the diagnostic mode. In addition, in response to an indication or input that a user determines that a target application is not a safe application, a diagnotor may uninstall the target application. In this way, a target application may run with high efficiency.

As described above, in a method for managing a permission policy of an application in an electronic terminal according to one or more exemplary embodiments, the corresponding permission policy of a target application may be configured flexibly in an electronic terminal. In addition, by adding a diagnotor, the user need not modify the codes of various APIs in a system in a process of granting permission policy, thereby improving extensibility of permission policy management. Furthermore, when configuring a diagnostic script of a target application, a new permission policy diagnostic point may be added through a configurator, and the corresponding API codes need not be modified during the process of configuration, thus, improving portability of permission policy management.

The methods and/or operations described above may implemented by an apparatus including, for example, a controller or at least one processor that controls a performing of the methods/operations, a display to provide a user interface, and an input device or mechanism from which to receive a user input. Additionally, it is understood that the methods and/or operations described above may be recorded, stored, or fixed in one or more computer-readable storage media that includes program instructions to be implemented by a computer to cause at least one processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

One should note that, the above embodiments are only exemplary, and the present inventive concept(s) is not limited to said examples. Those skilled in the art may understand that exemplary embodiments may be changed without departing from the principle and spirit of the present inventive concept(s), wherein, the scope of the present inventive concept(s) is defined in the claims and the equivalents thereof.

1. A method for managing a permission policy of an application in an electronic terminal, the method comprising:
obtaining an initial diagnostic script to create a diagnotor, a structure of the initial diagnostic script comprising a file header and a file content, wherein the file header comprises an application identifier, an identifier of a permission policy diagnostic point, an application programming interface corresponding to the permission policy diagnostic point, an instruction corresponding to the permission policy diagnostic point, and a setting for a user's decision with respect to the instruction upon execution of the instruction;
according to a control of the diagnotor, running a target application in a diagnostic mode; and
when the permission policy diagnostic point is triggered during the running of the target application, executing the instruction corresponding to the permission policy diagnostic point, receiving the user's decision in accordance with the setting for the user's decision, and recording the user's decision with respect to the executed instruction.

2. The method of claim 1, further comprising:
determining whether to update the initial diagnostic script; and
in response to determining to update the initial diagnostic script, updating the initial diagnostic script using the recorded user's decision.

3. The method of claim 2, further comprising:
determining whether the target application is completed; and
in response to determining that the target application is completed, updating the initial diagnostic script using the recorded user's decision and quitting the diagnostic mode.

4. The method of claim 1, wherein the initial diagnostic script is a pre-configured diagnostic script or a default diagnostic script of the electronic terminal.

5. The method of claim 4, wherein the initial diagnostic script is configurable by a user through a user interface provided by a predetermined configurator.

6. The method of claim 1, wherein the permission policy diagnostic point indicates a function point related to a permission policy of the target application.

7. The method of claim 1, further comprising in response to a user input indicating that the target application is a safe application, quitting the diagnostic mode.

8. The method of claim 1, further comprising in response to a user input indicating that the target application is not a safe application, uninstalling the target application.

9. The method of claim 1, wherein the obtaining the initial diagnostic script comprises:
determining whether the target application is safe; and
in response to determining that the target application is not safe, obtaining the initial diagnostic script to create the diagnotor.

10. The method of claim 9, wherein the determining whether the target application is safe comprises determining a degree of trust of a source of the target application.

11. The method of claim 1, further comprising:
determining whether the target application is completed; and
in response to determining that the target application is completed, updating the initial diagnostic script using the recorded user's decision and quitting the diagnostic mode.

12. The method of claim 1, wherein the initial diagnostic script comprises a plurality of information respectively corresponding to a plurality of permission policy diagnostic points, each of the plurality of information including an identifier of the corresponding permission policy diagnostic point, a corresponding instruction, and a setting for a user's decision with respect to the corresponding instruction.

13. A method for managing a permission policy of an application in an electronic terminal, the method comprising:
obtaining a diagnostic script to create a diagnotor, a structure of the diagnostic script comprising an instruction corresponding to a permission policy diagnostic point, and a setting for a user's decision with respect to the instruction upon execution of the instruction;
according to a control of the diagnotor, running a target application; and
when the permission policy diagnostic point is triggered during the running of the target application, executing the instruction corresponding to the permission policy diagnostic point and receiving the user's decision in accordance with the setting for the user's decision.

14. The method of claim 13, further comprising recording the user's decision with respect to the executed instruction.

15. The method of claim 14, further comprising:
determining whether to update the diagnostic script; and
in response to determining to update the diagnostic script, updating the diagnostic script using the recorded user's decision.

16. The method of claim 14, further comprising:
determining whether the target application is completed; and
in response to determining that the target application is completed, updating the diagnostic script using the recorded user's decision.

17. The method of claim 13, wherein the diagnostic script is a pre-configured diagnostic script or a default diagnostic script of the electronic terminal.

18. The method of claim 13, wherein the diagnostic script is configurable by a user through a user interface provided by a predetermined configurator.

19. The method of claim 13, wherein the permission policy diagnostic point indicates a function point related to a permission policy of the target application.

20. A non-transitory computer-readable recording medium having recorded thereon instructions executable by at least one processor to perform a method for managing a permission policy of an application in an electronic terminal, the method comprising:
obtaining a diagnostic script to create a diagnotor, a structure of the diagnostic script comprising an instruction corresponding to a permission policy diagnostic point, and a setting for a user's decision with respect to the instruction upon execution of the instruction;
according to a control of the diagnotor, running a target application; and
when the permission policy diagnostic point is triggered during the running of the target application, executing the instruction corresponding to the permission policy diagnostic point and receiving the user's decision in accordance with the setting for the user's decision.
